(19) United States
(12) Patent Application Publication
(10) Pub. No.: US 2006/0146702 A1
(43) Pub. Date: Jul. 6, 2006

(54) System and method for automatic rerouting of information when a target is busy

(75) Inventors: Thomas B. Hart, West Dundee, IL (US); Ronald T. Crocker, St. Charles, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 11/026,895

(22) Filed: Dec. 30, 2004

(51) Int. Cl. H04L 12/26

(52) U.S. Cl. 370/229

(57) ABSTRACT

A system and method transmits a data packet to a target mobile station (202) when the target mobile station is busy. The data packet is received at a packet function (PCF) (206). It is determined whether the target mobile station (202) is actively engaged in a session other than a data session. When the target mobile station (202) is engaged in a session that is something other than a data session, it is determined whether the data packet is small enough to be sent over the traffic channel to the target mobile station (202). The PCF (206) sends the data packet over the traffic channel to the target mobile station (202) when it is determined that the target mobile station (202) is actively engaged in the session other than a data session and the data packet is small enough to be sent over the voice channel.

### FIELD OF THE INVENTION

The field of the invention relates to the routing of communications through networks and, more specifically, to rerouting communications in a network when a mobile station is busy.

### BACKGROUND OF THE INVENTION

In communication systems, different types of mobile stations exchange different types of information with each other. Voice traffic and non-voice data are the types of information that are typically exchanged.

In many known systems, a packet may arrive at a point within the network for transmission to a target mobile station. This target mobile station may be engaged in a voice call and its data transmission capabilities may be in a dormant state. The packets arriving for transmission to the target mobile station are typically queued at a Packet Control Function (PCF), which is located within the infrastructure of many networks. Push-to-talk (PTT) requests, Session Initiation Protocol (SIP) INVITE messages, presence updates, and email server notifications are examples of messages that may be queued at the PCF. When a mobile is engaged in a call, however, the waiting data packets cannot be transmitted to the target mobile station. The inability to transmit these messages quickly to the mobile station impacts the performance of the system since message transmission is slowed.

Known systems have used concurrent services to support simultaneous voice and data communications. However, these concurrent services require costly additional equipment to be installed in the network. Further, since additional equipment and service features are used to support concurrent services, the cost to the consumer increases and this may make the service undesirable for many consumers.

### BRIEF DESCRIPTION OF THE DRAWINGS

FIG. 1 is a flowchart showing the routing of packets in a network according to the present invention;

FIG. 2 is a block diagram of a system for routing packets in a network according to the present invention;

FIG. 3 is a call flow diagram showing the routing of packets in a network according to the present invention; and

FIG. 4 is a block diagram of a device for routing packets in a network according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for transmitting a data packet to a target mobile station when the target mobile station is busy determines if the data packet to be sent to the target mobile station is sufficiently small and identifies if there is a session in progress at the target mobile station that is not a data session. This approach is easy and inexpensive to implement and does not require the purchase and use of costly additional equipment in the network.

In many embodiments of the invention, a data packet is received at a PCF in a network. The data packet is destined for a target mobile station. A determination is made if the target mobile station is actively engaged in a session other than a data session. When it is determined that the target mobile station is engaged in a session that is not a data session, it is further determined whether the data packet is small enough to be sent over the traffic channel via the Mobile Switching Center (MSC) to the target mobile station. If so, the PCF sends the data packet over the traffic channel to the target mobile station via the MSC.

In determining whether the packet is small enough to be transmitted to the target mobile station, the size of the data packet may be compared to a packet size threshold. In another example, the type of the packet is identified to determine if the packet is of a type having a known, small size. Once a determination has been made to transmit the packet, the data packet may be transmitted as a short data burst (SDB) packet or some other suitable form.

If the packet is determined to be too large to transmit to the target mobile station, attempts may be made to re-send the data packet after a predetermined period of time has expired. Furthermore, the number of data packets sent to the target mobile station may be limited to be less than a packet count threshold.

Thus, the present approaches allow data packets to be transmitted to a target mobile station while the target mobile station is actively engaged in a voice call. The approaches are easy to implement and do not require the addition of costly equipment to the network and can be easily added and fitted into current systems.

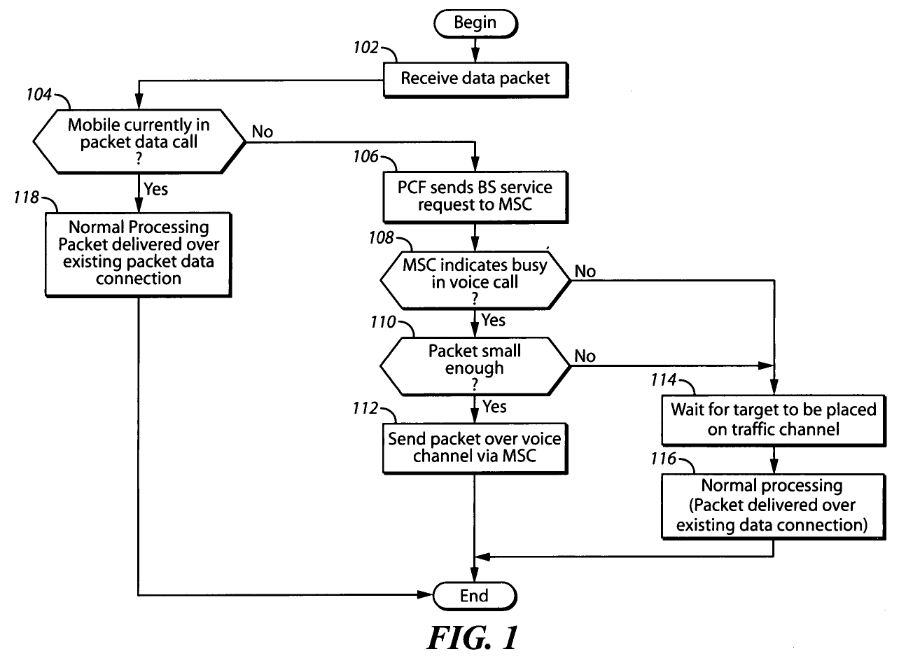

Referring now to FIG. 1, one example of an approach to transmit a data packet to a target mobile station when the target mobile station is busy is described. At step 102, a PCF receives a data packet. The PCF, typically residing in a Radio Access Network (RAN), controls the transmission of packets between a base station and a Packet Data Serving Node (PDSN).

At step 104, the PCF determines whether the target mobile station is engaged in a packet data call. If the answer is affirmative, the packet is delivered over an existing packet data connection at step 118. If the answer is negative, at step 106 the PCF sends a BS service request to the MSC. At step 108, the PCF determines if it has received a BS service response indicating the MSC is busy in a voice call. If the answer is affirmative, execution continues with step 110. If the answer is negative, at step 114 the system waits for the target to be placed on the traffic channel and at step 116 the packet is delivered over the existing data connection.

At step 110, it is determined if the packet is small enough to be transmitted over the voice channel to the target mobile station. For example, the PCF may determine if the size of the data packet is less than a predetermined threshold. The threshold may be fixed or variable. In another example, the PCF may determine if the packet is of a certain type that is known to have a small size. If the answer at step 110 is negative, then execution continues with step 114 as described above. If the answer is affirmative, then execution continues with step 112. Alternatively, the PCF may attempt to retransmit the packet later once a predetermined amount of time passes since the last attempt.

At step 112, a data packet is sent to the target mobile station over the voice traffic channel. The transmission may be in the form of a short data burst (SDB) packet signaling message, for instance. Other packet forms, formats, and messages may also be used for the transmission.

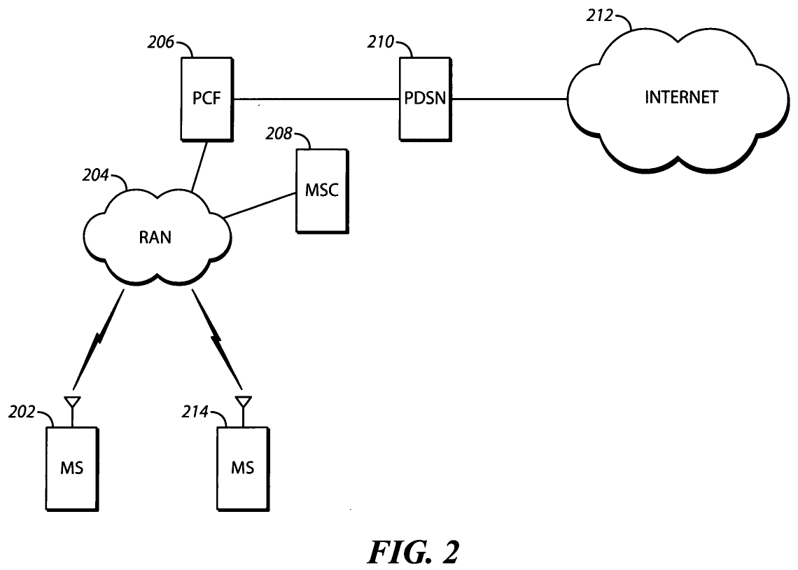

Referring now to FIG. 2, one example of a system for transmitting data to a target mobile station while the target mobile station is busy is described. The system comprises mobile stations 202 and 214, a RAN 204, a PCF 208, a MSC 208, a PDSN 210, and Internet 212.

The mobile stations 202 and 214 may be any type of mobile wireless device. For example, the mobile stations 202 and 214 may be cellular telephones, pagers, or personal digital assistants (PDAs). Other types of mobile stations are possible.

The RAN 204 contains the functionality required to allow the mobile stations 202 and 214 to communicate with each other and with other networks such as the Internet 212. The PCF 206 provides for the control of the transmission of packets between base stations in the RAN 204 and the PDSN 210. The MSC 208 provides an interface between the base stations and the switching subsystem of the Internet 212.

The PDSN 210 exchanges packets between mobile stations and the Internet 212. The PDSN 210 also exchanges packets with other networks. The Internet 212 may also be a combination of one or more networks, such as wireless cellular networks.

In one example of the operation of the system of FIG. 2, a data packet is transmitted from the Internet 212 to the PDSN 210. The PDSN 210 forwards the packet to the PCF 206.

The PCF 206 communicates with the RAN 204, and the RAN 204 communicates with the MSC 208 to identify the target mobile station. The target mobile station is paged and the MSC 208 determines whether the target mobile station is already engaged in a call. The PCF 206 forwards the data packet to the MSC 208.

The PCF 206 includes functionality to determine whether the target mobile station is actively using a dedicated voice channel and whether a data packet can be sent over the voice channel. In this regard, the PCF 206 determines whether the size of the data packet is small enough to be sent to the target mobile station. For example, the PCF 206 may check to see if the packet size is less than a predetermined size threshold. In another example, the PCF 206 can determine the type of the packet. Preferably, this can be accomplished by examining a field in the packet to identify the packet type. Examples of packets of small size include SIP Invite and text messages.

If the packet size is less than a predetermined size threshold, the MSC 208 delivers the data packet to the RAN 204. The RAN 204 then delivers the data packet to the target mobile station. The packet may be delivered in a form such as a Short Data Burst (SDB) packet. The packet is delivered over the traffic channel using techniques that are known to those skilled in the art.

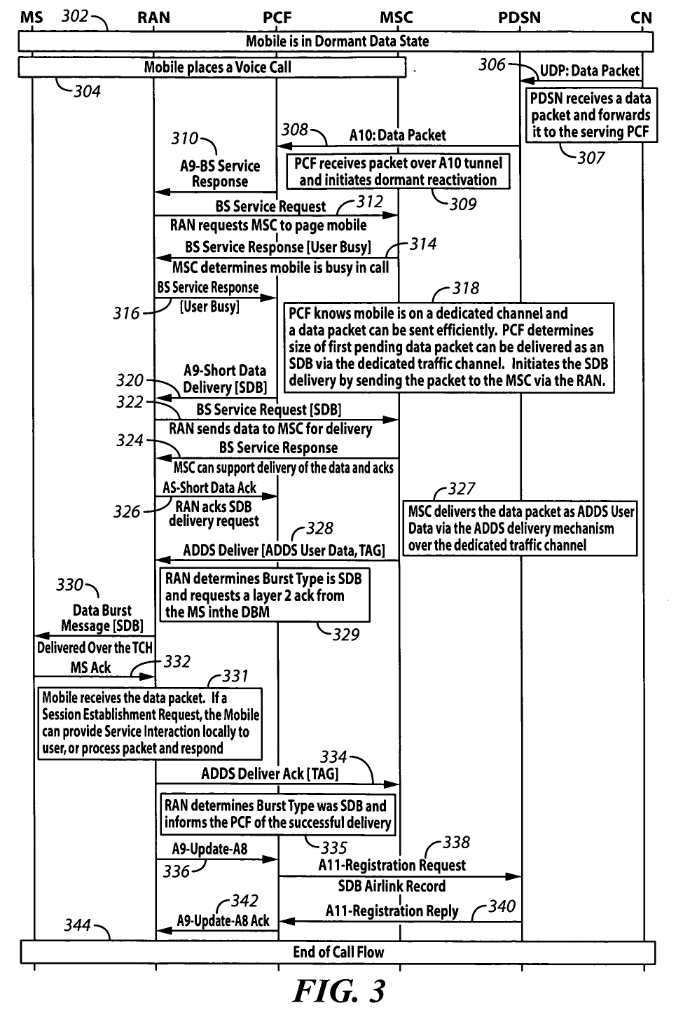

Referring now to FIG. 3, one example of an approach for sending a packet to a target mobile station is described. At step 302, the target mobile station is in a dormant data state. When in this state, the target mobile station is not receiving or transmitting data, but is waiting to do so. At step 304, the mobile station places a voice call and becomes engaged in the voice call. During this step, the mobile station and the infrastructure of the cellular network perform steps to set up and allow the mobile station to utilize a voice traffic channel and to engage in a call.

At steps 306 and 307, the data packet is sent from the cellular network to the PDSN. At steps 308 and 309, the PDSN forwards the data packet to the PCF. The data packet is transmitted, for instance, over an A10 tunnel. The PCF initiates a dormant reactivation. When a PCF receives a packet for a mobile station, dormant reactivation consists of the PCF determining whether the mobile station is dormant.

At step 310, a base system (BS) service response is sent from the PCF to the RAN. At step 312, a BS service request is sent from the RAN to the MSC whereby the RAN requests that a page be made to the mobile station. At step 314, the MSC returns a BS Service Response-User Busy message to the RAN. At step 316, the RAN sends the BS Service Response-User Busy message to the PCF.

At step 318, the PCF determines that the mobile station is on a dedicated channel and a data packet can be sent to the target mobile station if it is determined the packet is small enough. In this regard, the PCF determines the size of the first pending data packet that can be delivered as a SDB packet via the dedicated voice traffic channel in use by the target mobile station.

At step 320 the PCF initiates delivery by sending the packet to the MSC via the RAN by sending a Short Data Delivery message. At step 322, the RAN sends the packet to the MSC for delivery. At step 324, the MSC sends a BS Service Response message to the RAN indicating that the MSC can support delivery of the data and the acknowledgment messages.

At step 326, the RAN sends a short data acknowledgment message to acknowledge receipt of the SDB delivery request. At steps 327 and 328, the MSC formats and delivers the data packet as Application Data Delivery Service (ADDS) user data via the ADDS delivery mechanism over the dedicated voice traffic channel.

At step 329, the RAN determines the Burst Type is SDB and requests a Layer 2 (L2) acknowledgment from the MS in the data burst message. At step 330, the RAN sends the SDB to the MS over the voice traffic channel. At steps 331 and 332, an MS sends an acknowledgment message indicating that the target mobile station has received the data packet. If a session establishment request is received, the mobile station can provide service interaction locally to a user or process the packet and respond. At step 334, the ADDS deliver acknowledgment message is sent from the RAN to the MSC.

At steps 335 and 336, the RAN determines that the burst type was a SDB type and informs the PCF of the successful delivery via an update message. At step 338, the PCF sends a registration request to the PDSN. At step 340, the PDSN sends a registration reply message to the PCF. At step 342, an update acknowledgment message is sent from the PCF to the RAN. At step 344, execution ends.

Thus, the present approaches allow data packets to be transmitted to a target mobile station while the target mobile station is actively engaged in a voice call. The approaches are easy to implement, do not require the addition of costly equipment to the network and can be easily added and fitted into current systems. The approaches are also transparent to the user and require no additional user interaction.

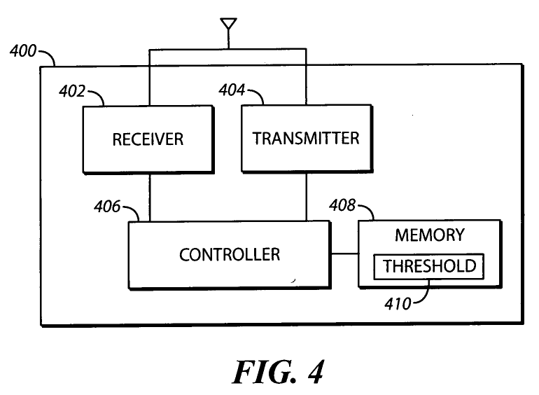

Referring now to FIG. 4, one example of a device 400 to route information in a network is described. In one example, this device may be a PCF. A receiver 402 receives an indication of when a target mobile station is busy. The receiver 402 also receives a data packet from a network. The packet includes information requesting that the packet be transmitted to the target mobile station. A transmitter 404 is used to transmit the packet to the target mobile station.

A controller 406 is coupled to the transmitter 404 and the receiver 402. A memory 408 is also coupled to the controller 406 and stores a packet size threshold 410. The controller 406 is programmed to send the packet to the network using the transmitter 404 when the indication shows that the target mobile station is busy and when the controller 406 determines that the size of the packet is less than the packet size threshold 410. Alternatively, the controller 406 may determine that the packet is of a type having a known small size.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for transmitting a data packet to a target mobile station comprising:
receiving the data packet at a packet control function (PCF);
determining whether the target mobile station is actively engaged in a session other than a data session, wherein the session is conducted over a traffic channel;
when the target mobile station is engaged in the session other than a data session determining whether the data packet is small enough to be sent over the traffic channel to the target mobile station; and
sending by the PCF the data packet over the traffic channel to the target mobile station when the determining indicates the target mobile station is actively engaged in the session other than a data session and the data packet is small enough to be sent over the voice channel.

2. The method of claim 1 wherein determining whether a data packet is small enough comprises comparing a size of the data packet to a packet size threshold.

3. The method of claim 1 wherein sending the data packet comprises sending a short data burst (SDB) packet.

4. The method of claim 1 wherein sending the data packet comprises sending by the PCF the packet to a mobile switching center (MSC) via a radio access network (RAN).

5. The method of claim 1 further comprising attempting to re-send the data packet at least a predetermined period of time after the data packet is determined to be not small enough.

6. The method of claim 1 further comprising constraining a number of data packets sent to the target mobile station to be less than a packet count threshold.

7. A device comprising:
a receiver for receiving an indication when a target mobile station is busy, the receiver also receiving a packet from a network, the packet comprising information requesting the packet be transmitted to a target mobile station;
a transmitter;
a controller coupled to the transmitter and the receiver, the controller programmed to send the packet to a network when the indication shows that the target mobile station is busy and when the controller determines that a size of the packet is less than a packet size threshold.

8. The device of claim 7 wherein the controller further comprises means for attempting to re-send the data packet later when the packet is determined to be larger than the threshold.

9. The device of claim 7 wherein the controller further comprises means for constraining a number of packets that can be sent to be less than the packet size threshold.

10. The device of claim 7 wherein the transmitter, receiver, and controller are located at a mobile switching center (MSC).

11. The device of claim 7 wherein the transmitter, receiver, and controller are located at a packet control function (PCF).

12. A system for transmitting a data packet to a target mobile station comprising:
a radio access network (RAN);
a target mobile station coupled to the RAN;
a mobile switching center (MSC) coupled to the RAN;
a packet control function (PCF) coupled to the RAN, the PCF receiving a data packet to be transmitted to the target mobile station, the PCF programmed to determine when the data packet is smaller than a threshold and to send the data packet to the MSC via the RAN when the target mobile station is busy and a size of the packet is less than the threshold; and
wherein the MSC transmits the data packet to the RAN over a voice channel.

13. The system of claim 12 further comprising a packet data serving node (PDSN) coupled to the PCF for transmitting the data packet to the PCF.

14. The system of claim 12 wherein the PCF further comprises means for attempting to re-send the data packet after the data packet is determined to be larger than the threshold.

15. The system of claim 12 wherein the PCF further comprises means for constraining a number of data packets that can be sent to be less than a threshold.

16. The system of claim 12 wherein the data packet sent by the MSC is a short data burst (SDB) packet.
